(19) United States
(12) Patent Application Publication
(10) Pub. No.: US 2012/0047302 A1
(43) Pub. Date: Feb. 23, 2012

(54) STORAGE SYSTEM

(75) Inventors: Wei-Fang ZHANG, SHANGHAI (CN); Tsu-Cheng LIN, TAIPEI CITY (TW)

(73) Assignee: INVENTEC CORPORATION, TAIPEI CITY (TW)

(21) Appl. No.: 12/960,450

(22) Filed: Dec. 3, 2010

(30) Foreign Application Priority Data
Aug. 23, 2010 (CN) 201010264310.6

(51) Int. Cl. G06F 13/00

(52) U.S. Cl. 710/301

(57) ABSTRACT

A storage system is provided, including: a power module for supplying electric energy to the storage system; a control module having at least one expansion interface, for externally connecting at least one server to provide a storage unit for the server, or for externally connecting at least one storage device to expand the storage capacity of the storage device; an adapter plate for connecting the power module and the control module; and a plurality of hard drive array units, each of which includes a hard drive backplane coupled to the adapter plate, and a plurality of hard drives separately coupled to the hard drive backplane. In addition, the control module and the hard drive expansion card in the storage system both have a redundant mechanism, so that when one of the components fails, the storage system remains running normally.

### RELATED APPLICATIONS

This application claims priority to China Application Serial Number 201010264310.6, filed Aug. 23, 2010, which is herein incorporated by reference.

### BACKGROUND

1. Field of Invention

The present invention relates to a data storage system. More particularly, the present invention relates to a storage device using a plurality of hard drive array units.

2. Description of Related Art

With the development of networks, performance of servers as a network device is improved progressively. As the network resources become more and more abundant, there are increasing requirements for a storage device dedicated for data storage. Among these servers, the storage device is a device dedicated for network data storage which is usually used in combination with a server. Since the storage device needs to be mounted on a rack together with the server, the appearance of the storage device is very similar to that of the server. The storage device has a chassis with a front panel at a front end thereof. When the chassis is mounted on the rack, the front is exposed at the front end of the rack for users to operate. A hard drive is the most important component in the storage device, and the storage capacity of a storage device, that is, how many hard drives can be plugged, is the most important technical indicator of the storage device. Usually, the hard drives of the storage device are hot-plug, and for easy operation, interfaces for plugging the hard drives are arranged on the front panel. However, the front panel has a limited space, so the number of the hard drives is restricted by the space of the front panel.

In view of this, it is a topic to be addressed by those skilled in the art that how to provide a flexibly expandable storage system, which is capable of providing a storage unit when it is externally connected to a server or is capable of expanding a storage capacity when it is externally connected to a storage device.

### SUMMARY

The invention provides a novel data storage system directed to solving the above defects of a data storage device in use in the prior art.

According to one aspect of this invention, a data storage system is provided, including:

a power module, for supplying electric energy to the data storage system;

a control module, having at least one expansion interface, for externally connecting at least one server to provide a storage unit for the server, or for externally connecting at least one storage device to expand the storage capacity of the storage device;

an adapter plate, for connecting the power module and the control module; and

a plurality of hard drive array units, each of which includes:

a hard drive backplane, coupled to the adapter plate; and

a plurality of hard drives, separately coupled to the hard drive backplane.

The control module includes a first control plate and a second control plate, which are redundant to each other. Preferably, the first control plate has a general-purpose input/output port connected to a reset signal input terminal of the second control plate, and the second control plate has a general-purpose input/output port connected to a reset signal input terminal of the first control plate. Preferably, the first control plate has an enable control port connected to in a first voltage, and the second control plate has an enable control port connected to a second voltage.

Each of the hard drive array units also includes a hard drive expansion card module, inserted on the hard drive backplane for expanding hard drive interfaces of the hard drive backplane. Preferably, the hard drive expansion card module includes a first hard drive expansion card and a second hard drive expansion card, which are redundant to each other. The first control plate controls the first hard drive expansion card, and the second control plate controls the second hard drive expansion card. The first hard drive expansion card and the second shard drive expansion card each include a plurality of first connecting terminals and a second connecting terminal, the hard drive backplane is coupled to the plurality of hard drives through the plurality of first connecting terminals and coupled to the adapter plate through the second connecting terminal.

The adapter plate also includes a plurality of SAS connectors, each of which is coupled to the hard drive backplane of the respective hard drive array unit.

Each of the hard drive array units also includes a connecting finger, and is connected to the hard drive backplane through the connecting finger.

Each of the hard drive array units also includes a plurality of temperature sensors, in which the temperature sensors detect a working temperature of the plurality of hard drives, the temperature data of the plurality of hard drives is transferred to the control module through the adapter plate, and the control module performs a unified management of fans based on a received fan control signal and the temperature data of the plurality of hard drives. Preferably, the control module performs data transmission with the adapter plate via an I²C bus.

The adapter plate also includes a SBB connector and is connected to the control module through the SBB connector.

The data storage system also includes an ON/OFF panel connected to the adapter plate, in which the ON/OFF panel has an ON/OFF button, through which an ON/OFF signal is sent out to perform an ON or OFF operation of the data storage system.

The expansion interface of the control module is a host bus adapter.

By using the data storage system of this invention, the number of hard drive interfaces is extended through the hard drive expansion card on the hard drive backplane of the respective hard drive array unit. When the storage system is connected to a server through the expansion interfaces thereof, it can provide a plurality of hard drives with large capacity for the server; and when the storage system is connected to a storage device through the expansion interfaces thereof, it can expand the storage capacity of the storage device. Furthermore, the control module and the hard drive expansion card on the hard drive backplane in the storage system of this invention each have a redundant mechanism, so that when one of the components fails, the storage system remains running normally.

### BRIEF DESCRIPTION OF THE DRAWINGS

The invention can be more fully understood by reading the following to detailed description of the embodiment, with reference made to the accompanying drawings as follows:

FIG. 1 shows a stereogram of a storage system according to an embodiment of this invention;

FIG. 2 shows a stereogram of a hard drive array unit 140 placed between two adjacent partition boards in FIG. 1 according to an embodiment of this invention.

FIG. 3 shows a circuit principle diagram of all components in the storage system according to an embodiment of this invention; and

FIG. 4 shows a circuit connection diagram of two control plates redundant to each other in a control module of the storage system according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

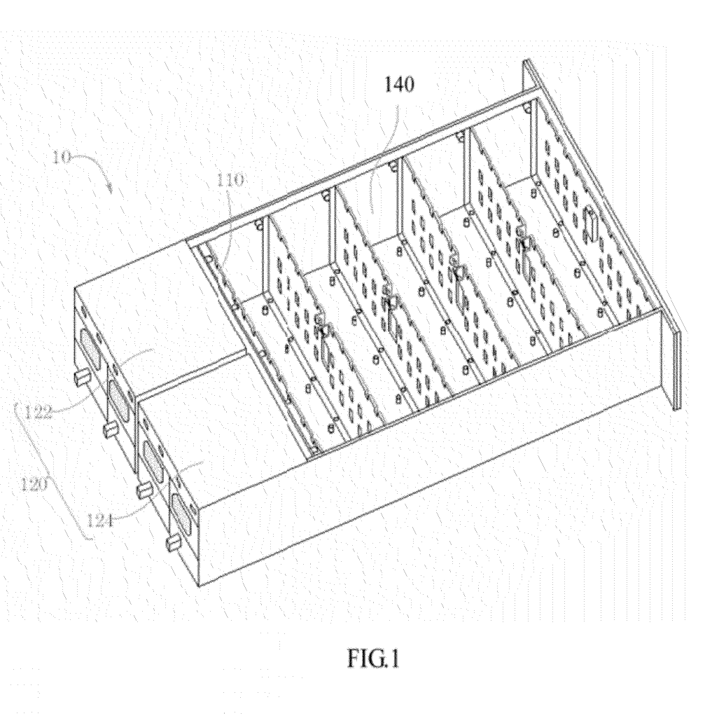

FIG. 1 shows a stereogram of a storage system according to an embodiment of this invention. Referring to FIG. 1, a storage system 10 mainly includes an adapter plate 110, a control module 120, a power module (not shown) and a plurality of hard drive array units 140 placed between two adjacent partition boards. A chassis of the storage system 10 includes a bottom plate and two side plates parallel to each other, in which the side plates are uprightly positioned on the bottom plate at both opposite sides. The adapter plate 110 is located between the two side plates, and is arranged to be perpendicular to the two side plates. The control module 120 has at least one expansion interface. When it is externally connected to a server through the expansion interface, the storage system 10 of this invention provides a storage unit for the server, for example, at this time, the expansion interface may be a host bus adapter; and when it is externally connected to a storage device through the expansion interface, the storage system 10 of this invention can expand the storage capacity of the storage device. In addition, the power module of the storage system 10 provides electric energy to this system.

According to an embodiment, the control module 120 includes a first control plate 122 and a second control plate 124, which are redundant to each other. In more detail, the first control plate 122 and the second control plate 124 are parallel to the bottom plate, and are perpendicularly connected to the adapter plate 110.

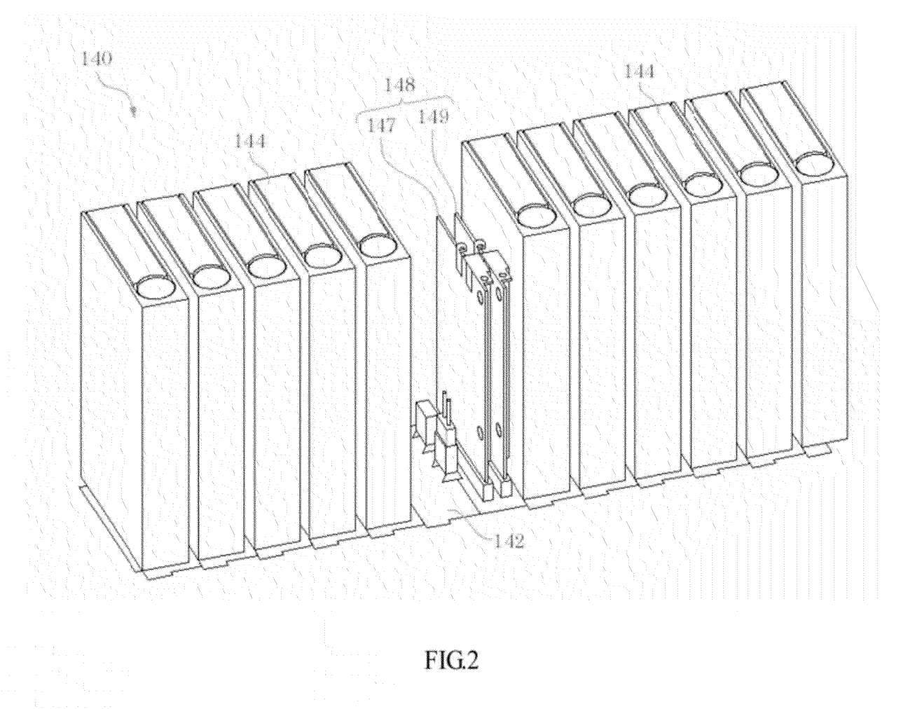

FIG. 2 shows a stereogram of a hard drive array unit 140 placed between two adjacent partition boards in FIG. 1 according to an embodiment of this invention. Referring to FIG. 2, the hard drive array unit 140 includes a hard drive backplane 142 and a plurality of hard drives 144 arranged on the hard drive backplane 142. Each of the hard drive array units 140 of the storage system 10 is coupled to the adapter plate 110 through the hard drive backplane 142, and the plurality of hard drives 144 are separately coupled to the hard drive backplane 142.

In one embodiment of this invention, in order to effectively extend the number of the hard drives 144 that can be controlled by the control module 120, each of the hard drive array units 140 also includes a hard drive expansion card module 148, which is inserted on the hard drive backplane 142 for expanding hard drive control interfaces of the hard drive backplane 142. Preferably, the hard drive expansion card module 148 includes a first hard drive expansion card 147 and a second hard drive expansion card 149, which are redundant to each other and control all hard drives 144 in the corresponding hard drive array unit 140 respectively. For example, when the control module 120 is provided with the first control plate 122 and the second control plate 124 which are redundant to each other, the first control plate 122 is used to control the first hard drive expansion card 147 and the second control plate 124 is used to control the second hard drive expansion card 149. That is to say, the control module 120 of the storage system 10 controls the hard drive expansion card module 148 of the plurality of hard drive array units 140, and the hard drive expansion card module 148 further controls the plurality of hard drives 144 in the corresponding hard drive array unit 140. In this manner, the storage system 10 may extend the number of the hard drives 144 that can be controlled by the control module 120 through the hard drive expansion card module 148.

The first hard drive expansion card 147 and the second hard drive expansion card 149 may both be configured to have a plurality of first connecting terminals and a second connecting terminal. The hard drive backplane 142 is coupled to the plurality of hard drives 144 through the plurality of first connecting terminals in the respective hard drive expansion card and coupled to the adapter plate 110 through the second connecting terminal in the respective hard drive expansion card.

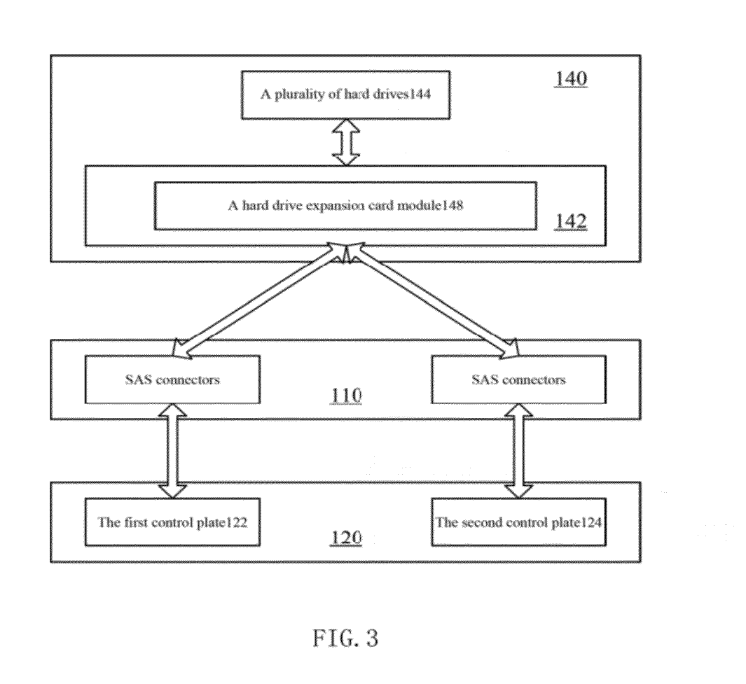

FIG. 3 shows a circuit principle diagram of all components in the storage system according to an embodiment of this invention. As shown in FIG. 3, the storage system includes a control module 120, an adapter plate 110, a plurality of hard drive array units 140, and a power module (not shown) for providing electric energy to the storage system. It should be understood by those skilled in the art that each of the hard drive array units 140 in the system is coupled to the adapter plate, and that FIG. 3 only shows any one of the hard drive array units to illustrate a connection relationship among them.

In the forgoing, the control module 120 may be configured to include the first control plate 122 and the second control plate 124 which are redundant to each other. The adapter plate 110 has a plurality of SAS connectors, which are coupled to the first control plate 122 and the second control plate 124 respectively. In addition, the adapter plate 110 is coupled to the hard drive backplane 142 through the SAS connectors. In one embodiment, each of the hard drive array units 140 in the storage system has a hard drive expansion card module 148 inserted on the hard drive backplane 142, and the hard drive backplane 142 is coupled to the adapter plate 110 and the plurality of hard drives 144 through the hard drive expansion card module 148. For example, the hard drive expansion card module 148 may be configured to include a first hard drive expansion card 147 and a second hard drive expansion card 149 which are redundant to each other. The first hard drive expansion card 147 controls all the hard drives 144 by the plurality of second connecting terminals, and the second hard drive expansion card 149 also controls all the hard drives 144 by the plurality of second connecting terminals. When the first hard drive expansion card 147 or the second hard drive expansion card 149 fails, a spare hard drive expansion card is put into service immediately, so that the storage system remains running normally.

In one embodiment, each of the hard drive array units 140 includes a connecting finger and is connected to the hard drive backplane 142 through the connecting finger. In addition, each of the hard drive array units 140 also includes a plurality of temperature sensors. The temperature sensors detect a working temperature of the plurality of hard drives 144, the temperature data of the plurality of hard drives 144 is transferred to the control module 120 through the adapter plate 110, and the control module 120 performs a unified management of fans based on a received fan control signal and the temperature data of the plurality of hard drives 144. Preferably, the control module 120 performs data transmission with the adapter plate 110 via an I²C bus.

Furthermore, the storage system 10 also includes an ON/OFF panel (not shown) connected to the adapter plate 110. The ON/OFF panel has an ON/OFF button, through which an ON/OFF signal is sent out to perform an ON or OFF operation of the storage system of this invention.

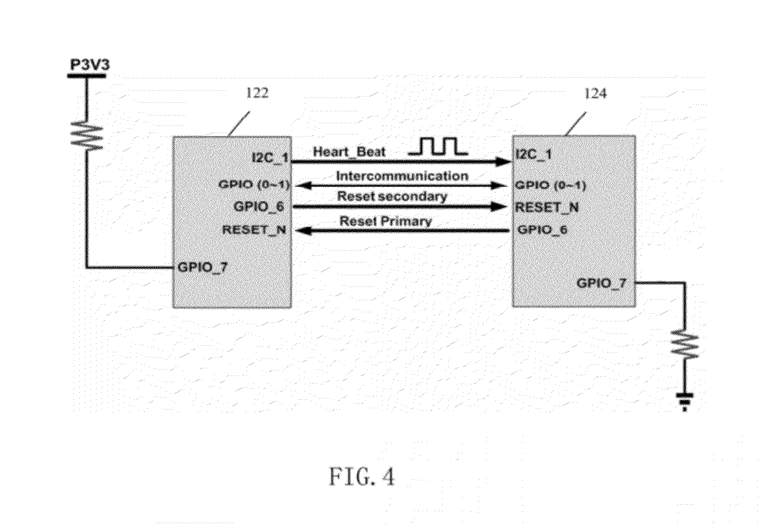

FIG. 4 shows a circuit connection diagram of two control plates redundant to each other in a control module of the storage system according to an embodiment of this invention. As shown in FIG. 4, a control module 120 includes a first control plate 122 and a second control plate 124, which are redundant to each other. When the storage system is running normally, one of the control plates is used to control all the hard drives 144 in each of the hard drive array units 140, and the other control plate is in a standby state.

In order to achieve the redundancy function between the two control plates, in one embodiment, a general-purpose input/output port (for example, Pin GPIO_6) of the first control plate 122 is connected to a reset signal input terminal (Pin RESET_N) of the second control plate 124, and meanwhile a general-purpose input/output port (for example, Pin GPIO_6) of the second control plate 124 is connected to a reset signal input terminal (Pin RESET_N) of the first control plate 122. In addition, an enable control port of the first control plate 122 may be connected to a first voltage (for example, 3.3 V), and an enable control port of the second control plate 124 is connected to a second voltage (for example, 0 V).

By using the storage system of this invention, the number of hard drive interfaces is extended through the hard drive expansion card on the hard drive backplane of the respective hard drive array unit. When the storage system is connected to a server through its expansion interfaces, it can provide a plurality of hard drives with large capacity for the server; and when the storage system is connected to a storage device through its expansion interfaces, it can expand the storage capacity of the storage device. In addition, the control module and the hard drive expansion card on the hard drive backplane in the storage system of this invention each have a redundant mechanism, so that when one of the components fails, the storage system remains running normally.

Although the present invention has been described in considerable detail with reference to certain embodiments thereof, other embodiments are possible. Various alternations and modifications can be made to these certain embodiments by those skilled in the art without departing the spirit and scope of the present invention. Such alternations and modifications are intended to fall within the scope of the appending claims.

What is claimed is:

1. A storage system, comprising:
a power module, for supplying electric energy to the storage system;
a control module, having at least one expansion interface, for externally connecting at least one server to provide a storage unit for the server, or for externally connecting at least one storage device to expand the storage capacity of the storage device;
an adapter plate, for connecting the power module and the control module; and
a plurality of hard drive array units, each comprising:
a hard drive backplane, coupled to the adapter plate; and
a plurality of hard drives, separately coupled to the hard drive backplane.

2. The storage system of claim 1, wherein the control module comprises a first control plate and a second control plate, which are redundant to each other.

3. The storage system of claim 2, wherein the first control plate has a general-purpose input/output port connected to a reset signal input terminal of the second control plate, and the second control plate has a general-purpose input/output port connected to a reset signal input terminal of the first control plate.

4. The storage system of claim 2, wherein the first control plate has an enable control port connected to a first voltage, and the second control plate has an enable control port connected to a second voltage.

5. The storage system of claim 2, wherein each of the hard drive array units further comprises a hard drive expansion card module, inserted on the hard drive backplane for expanding hard drive interfaces of the hard drive backplane.

6. The storage system of claim 5, wherein the hard drive expansion card module comprises a first hard drive expansion card and a second hard drive expansion card, which are redundant to each other.

7. The storage system of claim 6, wherein the first control plate controls the first hard drive expansion card and the second control plate controls the second hard drive expansion card.

8. The storage system of claim 7, wherein the first hard drive expansion card and the second hard drive expansion card each comprises a plurality of first connecting terminals and a second connecting terminal, wherein the hard drive backplane is coupled to the plurality of hard drives through the plurality of first connecting terminals and coupled to the adapter plate through the second connecting terminal.

9. The storage system of claim 1, wherein the adapter plate further comprises a plurality of SAS connectors, each of which is coupled to the hard drive backplane of the respective hard drive array unit.

10. The storage system of claim 1, wherein each of the hard drive array units further comprises a connecting finger and is connected to the hard drive backplane through the connecting finger.

11. The storage system of claim 1, wherein each of the hard drive array units further comprises a plurality of temperature sensors, wherein the temperature sensors detect a working temperature of the plurality of hard drives, the temperature data of the plurality of hard drives are transferred to the control module through the adapter plate, and the control module performs a unified management of fans based on a received fan control signal and the temperature data of the plurality of hard drives.

12. The storage system of claim 11, wherein the control module performs data transmission with the adapter plate via an I²C bus.

13. The storage system of claim 1, wherein the adapter plate further comprises a SBB connector, and is connected to the control module through the SBB connector.

14. The storage system of claim 1, wherein the storage system further comprises an ON/OFF panel connected to the adapter plate, wherein the ON/OFF panel has an ON/OFF button, through which an ON/OFF signal is sent out to perform an ON or OFF operation of the storage system.

15. The storage system of claim 1, wherein the expansion interface of the control module is a host bus adapter.
